(19) United States
(12) Patent Application Publication
(10) Pub. No.: US 2016/0019659 A1
(43) Pub. Date: Jan. 21, 2016

(54) PREDICTING THE BUSINESS IMPACT OF TWEET CONVERSATIONS

(71) Applicant: INTERNATIONAL BUSINESS MACHINES CORPORATION, Armonk, NY (US)

(72) Inventors: YURDAER N. DOGANATA, CHESTNUT RIDGE, NY (US); CHING-YUNG LIN, FOREST HILLS, NY (US); DAVID CORBALAN LUNA, BARCELONA (ES); JORDI C. MESTRE, BARCELONA (ES); XAVIER NOGUERA PAGES, BARCELONA (ES); MERCAN TOPKARA, SCARSDALE, NY (US); ZHEN WEN, SPRINGFIELD, NJ (US); DANNY L. YEH, IRVINGTON, NY (US)

(21) Appl. No.: 14/748,507

(22) Filed: Jun. 24, 2015

Related U.S. Application Data
(63) Continuation of application No. 14/729,170, filed on Jun. 3, 2015.

(30) Foreign Application Priority Data
Jul. 15, 2014 (ES) 14382276.5

(51) Int. Cl. G06Q 50/00; G06F 17/30

(52) U.S. Cl. CPC G06Q 50/01; G06F 17/30598; G06F 17/30345

(57) ABSTRACT

A system and methods are provided for identifying conversations in tweet streams. A method includes grouping tweet messages in the tweet streams into tweet groups, responsive to hashtags therefor and time intervals in which the tweet message were sent. The method further includes splitting the tweet groups into subgroups responsive to secondary hashtags and a time separation between the tweets messages. The method also includes clustering any of the subgroups into a respective same conversation responsive to word occurrences, word frequencies, and account holders. The method additionally includes merging any of the subgroups having different hashtags into the respective same conversation responsive to overlapping glossary and account lists. Each of the tweet groups and each of the subgroups correspond to a respective different one of the conversations when unable to be split, clustered, or merged.

### CROSS-REFERENCE TO RELATED APPLICATIONS

This application is a Continuation application of co-pending U.S. patent application Ser. No. 14/729,170, filed Jun. 3, 2015, which is incorporated herein by reference in its entirety.

### BACKGROUND

1. Technical Field

The present invention relates generally to social media and, in particular, to predicting the business impact of tweet conversations.

2. Description of the Related Art

Identifying conversations in social media is important. Many conversations that start in social media initiate important social events. The content of these conversations have impact on business as well. More than 500M active tweet users voluntarily send their opinions about world events, companies, products, people, governments, that is, about almost everything. The average number of tweets sent daily has reached 58 Million messages a day. Analysis of these tweet messages may help predict events that may impact the business of a company.

The conversations in social media involve many people separated in time and space and about various topics. Identifying each conversation and the associated conversers among many conversations happing at the same time is a significant problem. This is due to the fact that social media can have a myriad of conversations occurring simultaneously over a period of time where such conversations do not have well-defined beginning or ends or participant lists (i.e., potentially everyone can join), conversations can start under one hashtag and continue under one or more different hashtags, and conversations can stop for a long period of time and then restart. These issues make it significantly difficult to identify a conversation in social media as well as the associated conversers.

The known solutions to identifying conversations in social media include monitoring certain keywords related to a business or a topic and collecting messages that include these keywords. Other solutions use graph techniques to connect re-tweets and aim to identify social networks around a topic. However, these solutions do not provide enough precision in identifying conversations around a topic. Moreover, monitoring by using experts to increase precision is costly and can be prohibitive.

The known solutions to using social media for business include monitoring individual tweets and taking pro-active measures to protect brand reputation, running sentiment analysis on tweets for brand comparison, topic detection, predicting the social inclinations on a given topic, and predicting developing trends. However, none of these solutions address the problem of predicting the impact of emerging trends to a company's business in the future.

In social media conversations create virtual communities. Usually, when a hashtag is promoted as part of a social conversation or a message by enough individuals, a community is formed. These are ad hoc communities that have something to share on a common topic. The members of these ad hoc communities start a virtual conversation and exchange ideas around a set of topics that are anchored by the hashtags they choose. This creates a potential platform for the community to decide for an action towards a common goal. Organizations are interested in measuring the impact of the topics discussed in a social conversations usually promoted by hashtags to their business.

### SUMMARY

According to an aspect of the present principles, a method is provided for identifying conversations in tweet streams. The method includes grouping tweet messages in the tweet streams into tweet groups, responsive to hashtags therefor and time intervals in which the tweet message were sent. The method further includes splitting the tweet groups into subgroups responsive to secondary hashtags and a time separation between the tweets messages. The method also includes clustering any of the subgroups into a respective same conversation responsive to word occurrences, word frequencies, and account holders. The method additionally includes merging any of the subgroups having different hashtags into the respective same conversation responsive to overlapping glossary and account lists. Each of the tweet groups and each of the subgroups correspond to a respective different one of the conversations when unable to be split, clustered, or merged.

According to another aspect of the present principles, a method is provided for predicting the business impact of input tweet conversations. The method includes creating training data that includes pre-selected tweet conversations, pre-selected hashtags from the pre-selected tweet conversations, and labels. Each of the labels specifies a respective predicted business impact level for a respective one of the pre-selected tweet conversations and a respective one of the pre-selected hashtags included therein. The method further includes computing, by a processor, feature vectors for features extracted from the input tweet conversations. The method also includes forming a prediction model, trained by the training data, for predicting a respective business impact level for each of the input tweet conversations, by mapping respective predicted business impact levels to one or more feature vectors of each of the input tweet conversations.

According to yet another aspect of the present principles, a system is provided for predicting the business impact of input tweet conversations. The system includes a database for storing training data that includes pre-selected tweet conversations, pre-selected hashtags from the pre-selected tweet conversations, and labels. Each of the labels specifies a respective predicted business impact level for a respective one of the pre-selected tweet conversations and a respective one of the pre-selected hashtags included therein. The system further includes a feature vector computer, having a processor, for computing feature vectors for features extracted from the input tweet conversations. The system also includes an impact predictor, having a prediction model trained by the training data, for predicting a respective business impact level for each of the input tweet conversations, by mapping respective predicted business impact levels to one or more feature vectors of each of the input tweet conversations.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows exemplary tweet messages 200 to which the present principles can be applied, in accordance with an embodiment of the present principle;

FIG. 3 shows an exemplary system 300 for extracting tweet conversations, in accordance with an embodiment of the present principles;

FIG. 4 shows an exemplary method 400 for extracting tweet conversations, in accordance with an embodiment of the present principles;

FIG. 5 shows an exemplary system 500 for predicting the business impact of tweet conversations, in accordance with an embodiment of the present principles;

FIG. 6 shows an exemplary method 600 for predicting the business impact of tweet conversations, in accordance with an embodiment of the present principles; and

FIG. 7 represents the conditional probability 700 expressed in Equation (3) that given the observed feature values, F_{A}, the probability that impact is high as a function of Y_{A}, in accordance with an embodiment of the present principles.

### DETAILED DESCRIPTION OF PREFERRED EMBODIMENTS

The present principles are directed to predicting the business impact of tweet conversations. Correspondingly, the present principles are also directed to extracting conversations from social media messages.

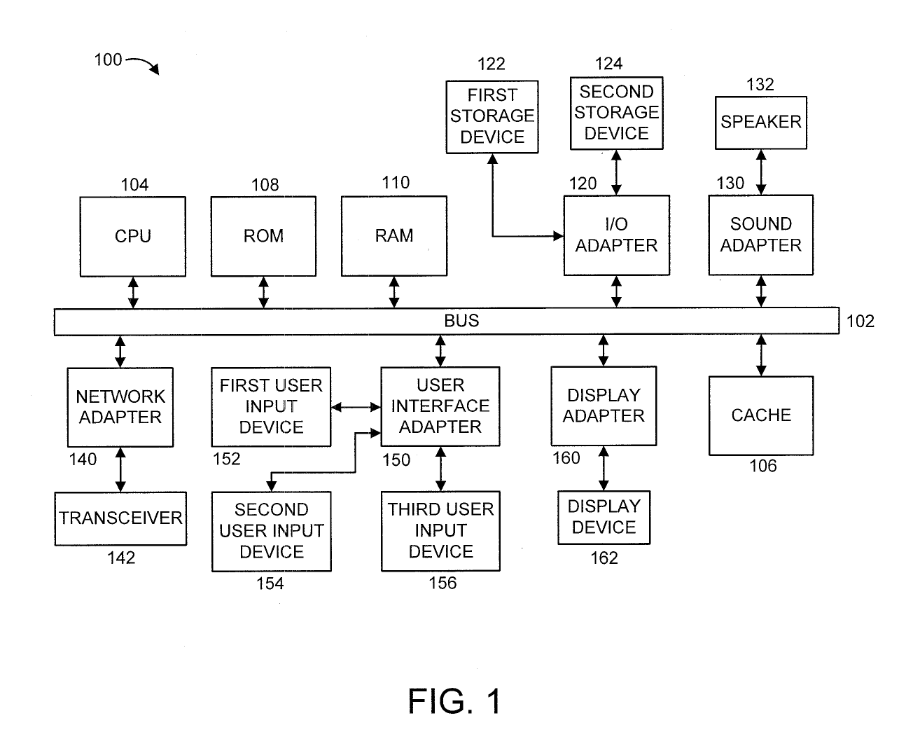

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operative coupled to system bus 102 by the sound adapter 130.

A transceiver 142 is operatively coupled to system bus 102 by network adapter 140.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

A display device 162 is operatively coupled to system bus 102 by display adapter 160.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

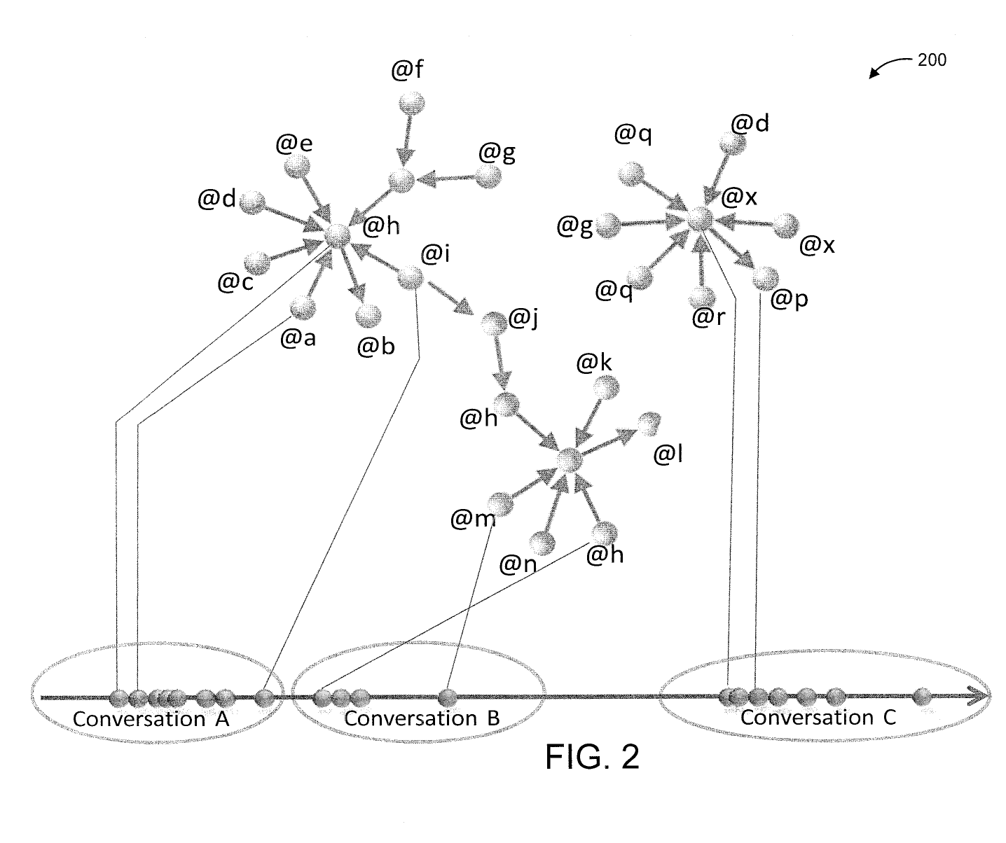

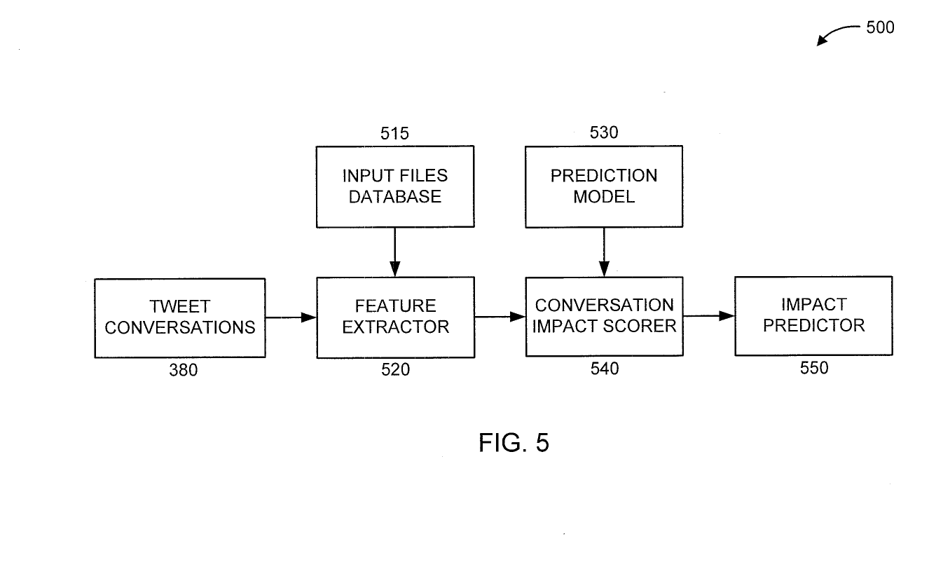

Moreover, it is to be appreciated that system 200 and system 500 respectively described below with respect to FIG. 2 and FIG. 5 are systems for implementing respective embodiments of the present principles. Part or all of processing system 100 may be implemented in one or more of the elements of system 200 and/or one or more of the elements of system 500.

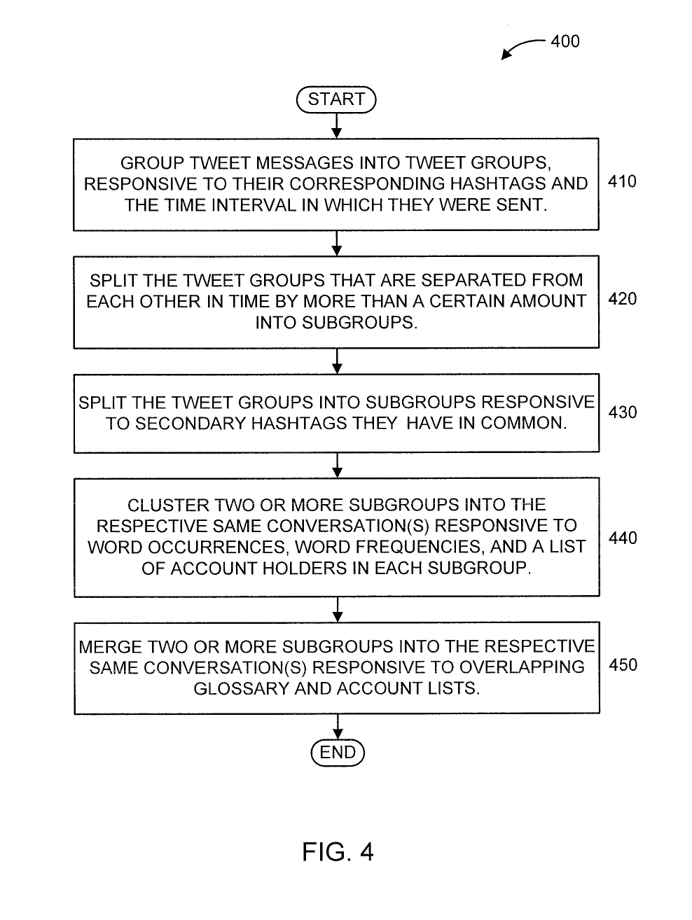

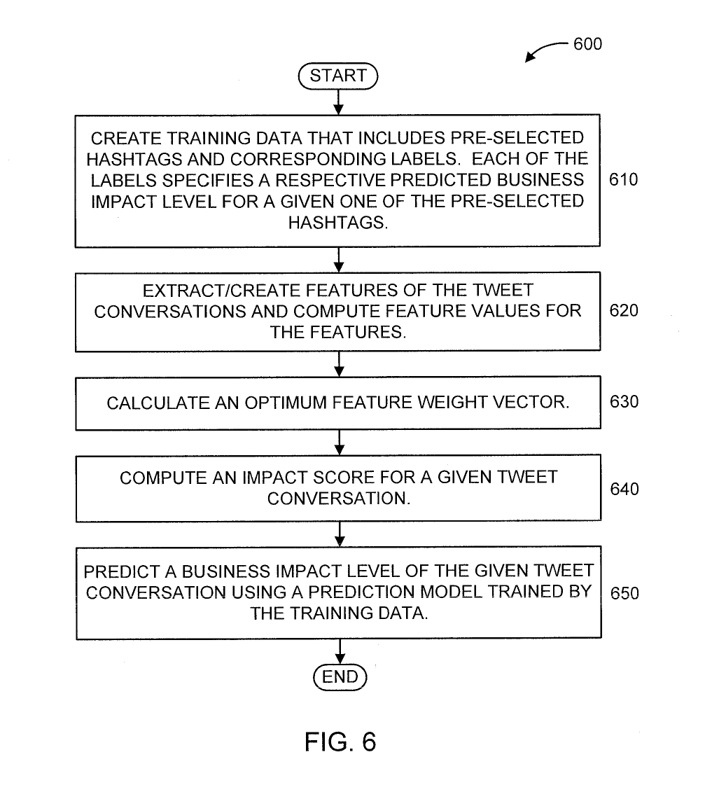

Further, it is to be appreciated that processing system 100 may perform at least part of the method described herein including, for example, at least part of method 400 of FIG. 4 and/or at least part of method 600 of FIG. 6. Similarly, part or all of system 200 and/or part of all of system 500 may be used to perform at least part of method 400 of FIG. 4 and/or at least part of method 600 of FIG. 6.

A description will now be given of extracting conversations from social media messages, in accordance with an embodiment of the present principles.

In an embodiment relating to the extraction of conversations from social media messages, the present principles group tweet messages with respect to the hashtags used in social media messages to form tweet groups. The tweet groups are then refined based on, for example, but not limited to, time stamps, a list of account holders, and/or the frequency and occurrence of keywords in each group. The stream of tweet messages are first grouped based on their hashtags and the time interval in which they were sent. The groups that are separated from each other in time by more than a certain amount are considered different conversations even if they belong to the same hashtag. Each group is further split into subgroups based on secondary hashtags. The word occurrences and frequencies in each subgroup are computed to determine if two subgroups belong to the same conversation or not. Another indication of two subgroups being part of the same conversation is the people who are involved in each of the subgroups. In addition to splitting groups of tweets to identify more refined conversations, the present principles also check if groups under different hashtags can be merged as one conversation because of the overlapping glossary and account lists.

FIG. 2 shows exemplary tweet messages 200 to which the present principles can be applied, in accordance with an embodiment of the present principles. The tweet messages 200 are connected through mention, retweets and hashtags along with user accounts. The tweet messages are lined up on the time axis in the order in which they were generated. The present principles propose a method to cluster tweets that belong to the same conversation, as depicted by the designations “conversation A” and “conversation B” in FIG. 2. Note that there may be multiple active conversations overlapping during the same time interval. It is to be appreciated that the phrases “tweets” and “tweet messages” are used interchangeably herein.

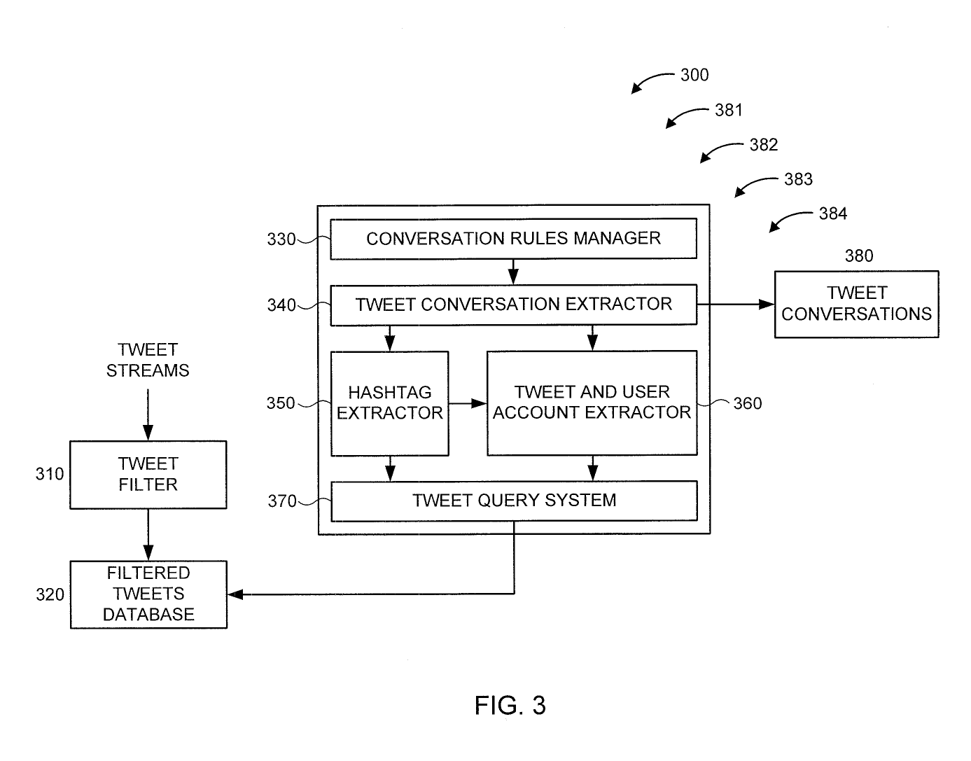

FIG. 3 shows an exemplary system 300 for extracting tweet conversations, in accordance with an embodiment of the present principles. The system 300 includes a tweet filter 310, a filtered tweets database 320, a conversation rules manager 330, a tweet conversation extractor 340, a hashtag extractor 350, a tweet and user account extractor 360, a tweets query system 370, and a tweet conversation database 380.

The elements of system 200 perform tweet grouping, tweet group splitting, tweet group clustering, and tweet group merging, as described in further detail herein below. Accordingly, at a higher level, the system 300 can be considered to include a tweet grouper 381, a tweet group splitter 382, a tweet group cluster determinator 383 and a tweet group merger determinator 384, with various elements 310 through 380 being comprised in various ones of elements 381 through 384. The tweet grouper 381 groups tweet messages in the tweet streams into tweet groups, responsive to hashtags therefor and time intervals in which the tweet message were sent. The tweet splitter 382 splits the tweet groups into subgroups responsive to secondary hashtags and a time separation between the tweets messages. The tweet cluster determinator 383 clusters the subgroups into a respective same conversation responsive to word occurrences, word frequencies, and account holders. The tweet merger determinator 384 merges any of the subgroups having different hashtags into the respective same conversation responsive to overlapping glossary and account lists. The various functions of the elements of system 200 are described in further detail herein.

The tweet messages are first filtered by the tweet filter 310 based on the keywords associated with a business or an organization and filtered tweet messages are collected in filtered tweets database 320. Tweet filter 310 connects to real-time and historical tweet data via GNIP Application Programming Interfaces (APIs) to receive filtered tweets and creates bags of tweets. The messages that are collected in the filtered tweets database 320 are accessed through the tweets query system 370. Applications can access tweet messages through the tweets query system 370 by using the interface definitions defined in TABLE 1. Hashtag extractor 350 utilizes the tweet query system 370 to extract the most common hashtags that have been used in the past. The amount of hashtags to be extracted is a parameter set by the tweet conversation extractor 340. Periodically the hashtag list is updated to capture new hashtags dynamically. For every hashtag identified by hashtag extractor 350, associated tweet messages and the information about user accounts are extracted by tweet and user account extractor 360. Different tweet collections can be obtained by querying the filtered tweets based on account names, hashtags, and keywords used. Such information can be provided by the tweet conversation extractor 340. The rules on how to group tweet collections to generate a virtual conversation are declared in the conversation rules manager 330. The system bootstraps by retrieving the hashtags that are found in the tweet messages among filtered tweets. The hashtags are extracted from the tweets using the hashtag extractor 350. The initial number of hashtags to be extracted is defined by the conversation rules manager 330. The first grouping based on hashtags is then further refined by using conversation rules implemented by the conversation rules manager 330. The main function of the tweet conversation extractor 340 is to implement the rules defined by the conversation rules manager 330. In order to implement the conversation rules, tweet conversation extractor 340 includes sub components/functions such as tweet grouper 381, a tweet group splitter 382, a tweet group cluster determinator 383 and a tweet group merger determinator 384. During runtime, the rules are ingested by tweet conversation extractor 340 which then invokes hashtag extractor 350 and tweet and user account extractor 360 to collect sets of tweet messages. Once the tweet messages are collected, grouping 381, splitting 382, clustering 383, and merging 384 sub functions of tweet conversation extractor 340 are utilized depending on the conversation rules to generate sets of tweet conversations 380.

Conversation rules can include, but are not limited to, the following:
Generating tweet groups based on common hashtag use;
Splitting a group into sub-groups if they are separated in time more than N minutes;
Splitting a group into sub-groups based on a secondary hashtag common in the messages;
Cluster sub-groups based on extracted glossary, keyword occurrence and frequency and account ids; and
Merge groups under single conversation based on their glossary and account list.

If a tweet collection cannot be split any further and cannot be merged with other collections, then it is considered a “conversation”.

Thus, TABLE 1 shows data access application programming interfaces (APIs) as follows:

TABLE 1
DATA ACCESS LAYER APIs

ArrayList hashtag getHashtags(int T):
Return all the hashtags received during the last T minutes.
ArrayList tweets getTweetsByHT(ArrayList hashtag, int T):
Return all tweets that include the specified hashtags.
ArrayList tweets getTweetByAccount(ArrayList user, int T):
Return all tweets sent by the specified user list.
ArrayList tweets getTweetByKeyword (ArrayList keywords, int T):
Return all tweets that include the specified keywords.
ArrayList user getUserByHashtag(ArrayList hashtags, int T):
Return all users that use the specified hashtags.

FIG. 4 shows an exemplary method 400 for extracting tweet conversations, in accordance with an embodiment of the present principles.

At step 410, group tweet messages into tweet groups, responsive to their corresponding hashtags and the time interval in which they were sent.

At step 420, split the tweet groups that are separated from each other in time by more than a certain amount into subgroups. Tweets in such split tweet groups will be considered to belong to different conversations, even if they belong to the same hashtag.

At step 430, split the tweet groups into subgroups responsive to secondary hashtags that they have in common.

At step 440, cluster two or more of the subgroups into the respective same conversation(s) responsive to word occurrences, word frequencies, and a list of account holders in each subgroup. For example, having a certain number of items (e.g., word occurrences, word frequencies, and/or account holders) above certain threshold amounts can be used for the clustering. As an example, having a word frequency over a value X can be used, where X is an integer used as a threshold value. Moreover, as another example, having Y number of word frequencies over a value of X can also be used, where X and Y are respective integers used as threshold values, with Y being a threshold for the number of word frequencies required over a certain value X, and X being a threshold for the value of the word frequencies (that must be surpassed, in this case surpassed Y times). To be clear, for values of Y=3 and X=100, then three separate words must occur at least one hundred times each in two subgroups being currently evaluated for those subgroups to be clustered as a single conversation. Of course, other ways of using such information can also be employed in accordance with the teachings of the present principles, while maintaining the spirit of the present principles.

At step 450, merge two or more of the subgroups into the respective same conversations(s) responsive to overlapping glossary and account lists. For example, having a certain number of overlapping items (e.g., glossary lists and/or account lists) above certain threshold amounts can be used for the clustering. Of course, other ways of using such information can also be employed in accordance with the teachings of the present principles, while maintaining the spirit of the present principles.

A description will now be given of predicting the business impact of tweet conversations, in accordance with an embodiment of the present principles.

One or more embodiments of the present principles are directed to predicting the impact of topics evolving from conversations to business. A solution that examines the myriad of conversations around a topic and determines their impact to a business is necessary to increase a company's awareness to upcoming social events.

The present principles utilize the concept of hashtags (#) that are used to tag tweet messages. Hashtags are used to associate a tweet message to a conversation topic. Hashtags are a very easy way of grouping tweets that are relevant to a particular conversation topic. Since hashtags are picked and tagged by the users, it truly reflects which conversation the tweet message belongs to without running any analytics. We propose to create a prediction model that will map the feature vector associated with a tweet conversation identified by one or more hashtags to a business impact level. Our approach is based on creating a labeled set of hashtags. In an embodiment, the labeled set of hashtags is created by business experts. As used herein, the term “business expert” refers to an individual deemed by an entity, such as a school or licensing authority, with possessing business knowledge above a layperson. Thus, for example, an individual with a degree in business can be used. In an embodiment, employment in a particular business field can be sufficient to render an impact prediction for a training data hashtag. In an embodiment, the tweet messages collected under the same hashtag are labeled as High, Low or No impact to the business, e.g., by the experts. Of course, the present principles are not limited to the preceding impact labels and corresponding levels and, thus, other impact labels and/or impact levels can be used given the teachings of the present principles provided herein, while maintaining the spirit of the present principles. The experts examine the tweets associated with the selected hashtags and make a decision about the impact. This labeled set of hashtags is then used as the basis for creating a training data set for our prediction model.

The core of our prediction model depends on creating a feature vector associated with every tweet conversation. We use features that are extracted from the tweet messages. The features that we extract for a tweet conversation can include, but are not limited to, one or more of the following: number of tweets; tweet accounts; influence measures; occurrence and frequencies of certain vocabulary words; precision and recall measure; number of retweets; and/or so forth.

In an embodiment, the system continuously collects tweets associated with each tweet conversation and dynamically generates features from the existing tweet sets for each tweet conversation. Note that the feature vectors may change in time since tweets keep streaming around the same hashtag. Accordingly, in an embodiment, features may be updated based on some interval, event occurrence, and/or so forth. The system periodically lists the tweet conversation associated with one or more hashtags with their impact on a particular time.

FIG. 5 shows an exemplary system 500 for predicting the business impact of tweet conversations, in accordance with an embodiment of the present principles.

The system 500 includes tweet conversation extractor 380 (initially shown in FIG. 3), an input files database 515, a feature extractor 520, a prediction model 530, a conversation impact scorer 540, and an impact predictor 550. While the preceding elements are shown as standalone elements in FIG. 5, it is to be appreciated that in other embodiments, the functions of two or more elements can be combined into a single element. These and other variations of the system 500 are readily determined by one of ordinary skill in the art, while maintaining the spirit of the present principles.

The tweet conversations 380 that are extracted by using the system depicted in FIG. 3 are then sent to the feature extractor 520 where the features of the tweet conversations associated with one or more hashtags are extracted and their values are computed. Some feature values can depend on the information obtained from GNIP such as user Klout (user online social influence) scores, account information, and so forth. Some other feature values, on the other hand, can use the information defined by business owners such as accounts of influencers, salient keywords and phrases, significant media and web links, and/or subsidiary information. The information provided by the business owners can be stored in the input files database 515. The feature extractor 520 reads the weights of the entities mentioned from an input file stored in the input files database 515 along with account information obtained through a GNIP interface and creates the feature vector, e.g., such as feature vector F_{A}={f_{A}_{₀}, f_{A}_{₁}, . . . f_{A}_{ₘ}} in Equation (2). The prediction model 530 can be used to provide the solution to Equation (9) and delivers the optimum feature weight vector, e.g., such as feature weight vector W={w₀, w₁, . . . wₘ}. The conversation impact scorer 540 computes an impact score, e.g., impact score Y_{A}=W^{T} F_{A} in Equation (7). The impact predictor 550 decides the impact level of a hashtag discussion. The impact predictor 550 can decide the impact level, e.g., using Equation (6).

FIG. 6 shows an exemplary method 600 for predicting the business impact of tweet conversations, in accordance with an embodiment of the present principles.

At step 605, create training data that includes pre-selected hashtags and corresponding labels therefor. Each of the labels specifies a respective predicted business impact level for a given one of the pre-selected hashtags.

At step 610, receive tweets and create groups of tweets therefrom. In an embodiment, the received tweets are pre-filtered. In an embodiment, the received tweets are grouped together such that tweets with the same hashtag are in the same group. The hashtag is of the type used to model a hashtag discussion, as described in further detail herein. Hence, all tweets in a given group are presumed to correspond to the same hashtag discussion.

At step 620, extract/create features of the tweet conversations and compute feature values for the features. Step 620 can include reading the weights of entities specified in an input file along with account information obtained through a GNIP interface in order to extract/create a feature vector F_{A}={f_{A}_{₀}, f_{A}_{₁}, . . . f_{A}_{ₘ}}.

At step 630, calculate an optimum feature weight vector W={w₀, w₁, . . . wₘ}.

At step 640, compute an impact score for a given tweet conversation, e.g., Y_{A}=W^{T} F_{A}. The impact score can be computed, e.g., as specified in Equation (7).

At step 650, predict a business impact level of the given tweet conversation using a prediction model trained by the training data. The business impact level can be determined, e.g., as specified in Equation (6).

Hashtags were originally developed to create groups on TWITTER® for tracking topics by adding metadata to tweet messages. A hashtag is simply created by using a pound (#) sign followed by a word or an acronym. Since it is a community-driven tagging process, new hashtags are produced every day for the most obscure of subjects and guessing the meaning of a hashtag is not possible. As an example, #sxsw is a hashtag used to track the annual festival in Austin, Tex. In addition, there is no rule against using an old hashtag for a new topic which makes it even harder to guess the topics associated by a hashtag. While it is possible to search for tweets that constitute a hashtag microblog, it is not a practical approach to manually search for all hashtag microblogs manually and measure their impact. Therefore, in order to help automate the impact analysis, we created a model of a hashtag microblog as explained below.

A description will now be given regarding modeling a tweet conversation, in accordance with an embodiment of the present principles.

A tweet conversation includes tweet messages that, in turn, include the same hashtag or same set of hashtags. A tweet conversation, H_{A}, is defined as follows:

H_{A}={t_{A}_{₁},t_{A}_{₂}, . . . , t_{A}_{_{N}}} (1)

where # A is a hashtag, A is the word or acronym used for tagging, and t_{A}_{ⱼ}εH_{A} for j=1, . . . N are all the tweets that include the hashtag # A. There is a timestamp associated with every tweet and the duration of a virtual tweet conversation, Duration (H_{A}), defined as the time difference between the last and the first tweets that belongs to H_{A}, as follows:

Duration(H_{A})=time(t_{A}_{_{N}})−time(t_{A}_{₁})

Since hashtags are not registered and can be reused at different times in different contexts, we assume that the time difference between two consecutive tweets in a tweet conversation cannot be greater than 1 week. Therefore, if a tweet conversation does not receive any tweet for one week, we assume that the discussion is ended. Any tweet that includes the same hashtag and is received a week after the discussion ends starts a new discussion with the same hashtag. Thus, there can me multiple discussions separated in time that are defined by the same hashtags.

A description will now be given regarding the features of a hashtag discussion, in accordance with an embodiment of the present principles.

The features represent the distinctive attributes of a tweet conversation. In an embodiment, we defined about 32 features that capture different aspects of a tweet conversation in five categories. These five categories are listed as account, keyword, location, language and other categories below. The significance of features may change as the business context change. Thus, different features may be important at different times and to different businesses. Moreover, while features in five categories are described herein, in other embodiments, these and/or other categories can be used, as well as these and/or other features. Hence, it is to be appreciated that the present principles are not limited to the categories and/or features described herein and, thus, given the teachings of the present principles provided herein, one of ordinary skill in the art will contemplate these and other categories and/or these and other features to which the present principles can be applied while maintaining the spirit of the present principles. Our prediction model uses the most significant features of the tweet conversation that influence the business impact. The feature vector of a tweet conversation, H_{A}, is defined as F_{A}:

F_{A}={f_{A}_{₀},f_{A}_{₁}, . . . f_{A}_{ₘ}} (2)

where f_{A}_{ⱼ} is the value of the j^{th} feature.

A description will now be given regarding exemplary account features, in accordance with an embodiment of the present principles.

Account features are defined based on the information about the accounts that participate to a tweet conversation. Some of these accounts may be considered influential by the business owners. We capture the accounts that are considered influential by the experts in a hash table that includes the list of accounts and their assumed measure of influence to the particular business for which the prediction model is developed. TABLE 2 shows an exemplary table format used to store the names of the influencer accounts and their associated weight of influence. As an example, in TABLE 2, Influencer₁ is considered influential account with associated weight i₁. TABLE 2 is provided as an external input to our prediction model and can be modified by the business owners. The account features include statistics about the accounts that participated in the discussion such as, but not limited to, the following: percentage of influencers who participated; average, max and min influence and Klout scores of participants; information about journalists who participated; and/or statistics about the number of accounts and their followers in a discussion. In an embodiment, the feature values are either numeric or Boolean. Of course, other types of values can also be used. It is to be noted that feature definitions are independent of the hashtag # A. It is to be further noted that while one or more tables are described herein, the present principles are not limited to the same and, thus, can use any type of data construct in order to implement the teachings of the present principles, while maintaining the spirit of the present principles.

TABLE 2

| Influencer | Weight |
|---|---|
| Influencer₁ | i₁ |
| Influencer₂ | i₂ |
| . . . | . . . |

Some exemplary account features that can be defined for a hashtag community are listed below as follows:
f₀: Number of different accounts in the hashtag community.
f₁: The percentage of the accounts that are influential.
f₂: The average measure of influence of the participants from influencer's list.
f₃: The max measure of influence of the participants from influencer's list.
f₄: The min measure of influence of the participants from influencer's list.
f₅: If an influencer is mentioned.
f₆: Number of influencers.
f₇: Percentage of tweets sent by the influencers.
f₈: Average Klout score of the participants.
f₉: Max Klout score of the participants.
f₁₀: Min Klout score of the participants.
f₁₁: Average number of followers, i.e., total number of followers of a discussion. divided by the number of participants.
f₁₂: Maximum number of followers among different accounts in the discussion.
f₁₃: Minimum number of followers among different accounts in the discussion.
f₁₄: If a journalist is in the list of participants.

A description will now be given regarding exemplary keyword features, in accordance with an embodiment of the present principles.

Keyword features are defined based on some salient words or phrases, subsidiary names, web site addresses, and/or media links specified by experts that have relevance to the business which, in an embodiment, are stored in a table with their relevance score and categories. As the context changes, the keywords and their relevance score may change by the experts. TABLE 3 shows 4 different keyword feature types (word, subsidiary, websites, and media) with their associated weights. The keyword feature types are numeric. TABLE 3 is also used as an external input to our prediction model.

TABLE 3

| Word | Weight | Websites | Weight |
|---|---|---|---|
| word₁ | x₁ | website₁ | y₁ |
| word₂ | x₂ | website₂ | y₂ |
| . . . | . . . | . . . | . . . |
| Subsidiary | Weight | Media | Weight |
| subsidiary₁ | z₁ | media₁ | q₁ |
| subsidiary₂ | z₂ | media₂ | q₂ |
| . . . | . . . | . . . | . . . |

Some exemplary keyword features that can be defined for a hashtag community are listed below as follows:
f₁₅: Percentage of the keywords covered.
f₁₆: Sum of the keyword weights.
f₁₇: Smallest keyword weight.
f₁₈: Largest keyword weight.
f₁₉: Sum of the weights of web links.
f₂₀: Sum of the weights of media links.
f₂₁: If a subsidiary is mentioned.

A description will now be given regarding exemplary location features, in accordance with an embodiment of the present principles.

Location features are based on the location information that the users stated in their profile. Location features are used to give an idea about the geographical dispersion of the account owners. In an embodiment, the percentage of users who are co-located based on their profile information is ranked and the highest two percentages are used as location features. Of course, other numbers can also be used. Some exemplary location features that can be defined for a hashtag community are listed below as follows:
f₂₂: Highest percentage of co-located users.
f₂₃: Second highest percentage of co-located users.

A description will now be given regarding exemplary time features, in accordance with an embodiment of the present principles.

Time features are statistics about the time between two consecutive tweets and the duration of the discussion. Some exemplary time features that can be defined for a hashtag community are listed below as follows:
f₂₄: duration of the discussion.
f₂₅: average time between two consecutive tweets.
f₂₆: standard deviation of the time between two consecutive tweets.

A description will now be given regarding other exemplary features, in accordance with an embodiment of the present principles.

Some other exemplary features that can be defined for a hashtag community are listed below as follows:
f₂₇: number of tweets.
f₂₈: number of retweets.
f₂₉: most common language.
f₃₀: second most common language.
f₃₁: percentage of the most common language.
f₃₂: percentage of the second most common language.

A description will now be given regarding a logistic regression model for prediction, in accordance with an embodiment of the present principles.

Our aim is to classify a tweet conversation as high impact or low impact. In an embodiment, this is a binary classification problem where the input is the feature vector of a discussion and the output is either HIGH or LOW. Given the feature vector of a tweet conversation, if the probability of impacting high is above a certain threshold, the discussion is classified as HIGH. Hence, the conditional distribution of the output decision is used to make a decision. Using logistic regression, we obtain the probability of impact given the observed feature values as follows:

$$\begin{matrix}Pr ( {H}_{A} = “ HIGH ” \vert {F}_{A} ) = \frac{1}{1 + exp ( {w}_{0} + {Σ}_{i} {w}_{i} {f}_{i} )} & ( 3 ) \\ Pr ( {H}_{A} = “ LOW ” \vert {F}_{A} ) = \frac{exp ( {w}_{0} + {Σ}_{i} {w}_{i} {f}_{i} )}{1 + exp ( {w}_{0} + {Σ}_{i} {w}_{i} {f}_{i} )} & ( 4 )\end{matrix}$$

where wᵢ is the coefficient of the i^{th} feature. The decision boundary for the impact of H_{A} is obtained by taking the ratio of Equation (3) and Equation (4) as follows:

$$\frac{P ( {H}_{A} = “ LOW ” \vert {F}_{A} )}{P ( {H}_{A} = “ HIGH ” \vert {F}_{A} )} = exp ( {w}_{0} + {\sum }_{i} {w}_{i} {f}_{i} ) \qquad ( 5 )$$

Hence, given the observed feature values, F_{A} the decision regions for the impact of HA are expressed as follows:

$$\begin{matrix}{H}_{A} = \{ \begin{matrix}H = HIGH & if {Y}_{A} < 0 \\ L = LOW & if {Y}_{A} \geq 0\end{matrix} \\ where & ( 6 ) \\ {Y}_{A} = {w}_{0} + {\sum }_{i} {w}_{i} {f}_{i} & ( 7 )\end{matrix}$$

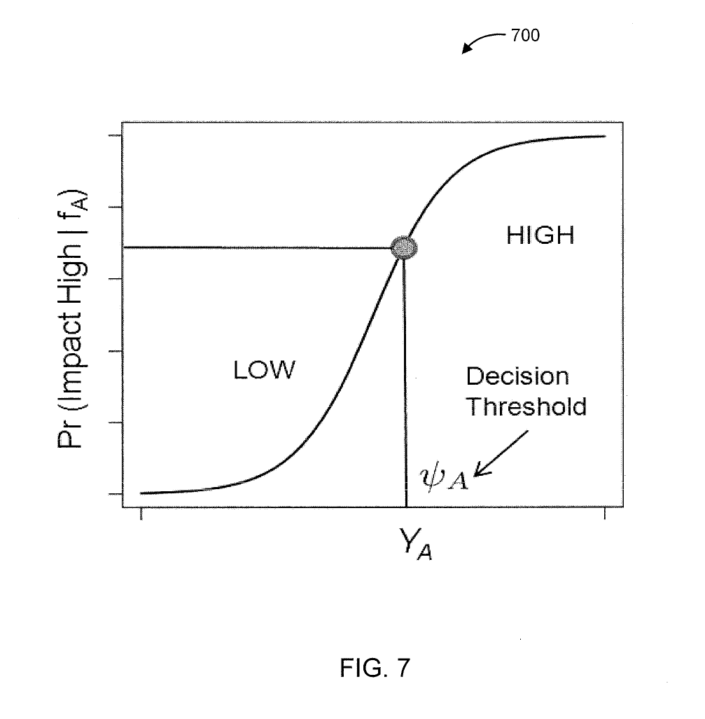

In Equation (7), Y_{A} is called the “impact score” of the tweet conversation. As the value of Y_{A} increases, the likelihood of having a high business impact increases as well. FIG. 7 represents the conditional probability 700 expressed in Equation (3) that given the observed feature values, F_{A}, the probability that impact is high as a function of Y_{A}, in accordance with an embodiment of the present principles. The coefficients, wᵢ, are selected by minimizing the prediction error against a training data set as explained hereinafter.

A description will now be given regarding training the feature weights, in accordance with an embodiment of the present principles.

In an embodiment, in order to obtain the coefficients of the feature weights, wᵢ, that minimize the prediction error, training data is used. The training data is generated by labeling the target class, Y_{A}, as “HIGH” or “LOW” for a sample tweet conversation. Hence, the training data set is as follows:

{H_{A}_{ᵢ}⁽ⁱ⁾,F_{A}_{ᵢ}⁽ⁱ⁾} for i=1, . . . n (8)

where, n is the number of discussion samples in the training set, H_{A}⁽ⁱ⁾ is the labeled impact of the i^{th} sample discussion, # Aᵢ is the associated hashtag, and F_{A}_{ᵢ}⁽ⁱ⁾ is the associated feature value vector. The optimum coefficients can be calculated by maximizing the following conditional log likelihood function as follows:

max_{w}L(w)=ln ΠPr(H_{A}^{(j)}|w,F_{A}⁽ⁱ⁾) (9)

where Pr is the conditional probability of the labeled impact given a particular impact, Π represents the multiplication over all sample data, and max_{w} indicates that w that maximizes the function on the right hand side should be selected.

A description will now be given regarding feature selection, in accordance with an embodiment of the present principles.

When the features are selected for tweet conversations, their predictor power is not known in advanced and may change based on the nature of the business. As an example, for some type of discussions the location may be more important than the content, hence the predictor power of f_{A}_{₁₉} is expected to be more than f_{A}_{₁₂}. Some features may not have significant contribution to the prediction of the impact. If a feature does not have significance, we drop that feature from the model.

In an embodiment, in order to determine how well each feature predicts the impact of the discussion, we compute the importance of each feature by using the p value based on Pearson's chi-square test. The p value is a measure of independence between the observed feature values and their expected frequencies under the null hypothesis that feature values are independent of the impact level. The observed feature values under consideration are placed into I bins to generate a finite number of categories. The number of output categories is J=2, since the impact can either be HIGH or LOW. Under the null hypothesis, Pearson's chi-square converges asymptotically to a chi-square distribution χ_{d}² with degrees of freedom d=(I−1)(J−1), hence d=I−1. The p value based on Pearson's chi-square χ² is calculated as follows:

$$\begin{matrix}p = Prob ( {χ}_{d}^{2} > {χ}^{2} ) , \\ where & ( 10 ) \\ {χ}^{2} = {\sum }_{i = 1}^{I} \frac{{( {N}_{iH}^{( k )} - \overline{{N}_{iH}^{( k )}} )}^{2}}{\overline{{N}_{iH}^{( k )}}} + \frac{{( {N ( k )}_{iL} - \overline{{N ( k )}_{iL}} )}^{2}}{\overline{{N}_{iL}^{( k )}}} & ( 11 )\end{matrix}$$

Here I is the total number of bins that are used to categorize the feature values. N^{(k)}ᵢⱼ is the number of cases for the k^{th} feature with H_{A}=j for jε{H, L}. The expected bin frequencies under the null hypothesis are given by the following:

N̅ᵢ̅ⱼ̅^̅{̅(̅k̅)̅}̅=N_{i.}^{(k)}N_{.j}^{(k)}/N (12)

where, N_{i.}^{(k)}=N_{iH}^{(k)}+N_{iL}^{(k)} and N_{.j}^{(k)}=Σᵢ₌₁^{N}Nᵢⱼ^{(k)}.

The p value indicates how likely the observed feature values are under the null hypothesis. Therefore, we reject the null hypothesis that the selected feature is independent of the impact level when the p value is less than 5%. Hence, by using Equation (10), we select the features that have p values less than 0.05 as features with significant predictive power in our logistic regression model and drop the others. For the model we built for a bank, 20 out of 33 features passed the significance test and they are ranked below in TABLE 4 based on their predictive power, i.e., based on how small their p values are:

TABLE 4

| (1-p)-value | Feature | description |
|---|---|---|
| 0.9999 | f₁₇ | Minimum keyword weight |
| 0.9999 | f₁₈ | Maximum Keyword weight |
| 0.9999 | f₁₀ | Maximum Klout score of participants |
| 0.9999 | f₁₅ | Percentage of the keywords covered |
| 0.9999 | f₅ | Mention of an influencer |
| 0.9999 | f₆ | Number of influencers |
| 0.9999 | f₁₆ | Keyword weight sum |
| 0.9999 | f₃₂ | Second most common language |
| 0.9999 | f₉ | Maximum Klout score |
| 0.9998 | f₀ | Number of different accounts |
| 0.9997 | f₂₈ | Number of retweets |
| 0.9995 | f₈ | Average Klout score |
| 0.9991 | f₂₄ | Duration |
| 0.9987 | f₃₁ | Most common language |
| 0.9980 | f₇ | % of the tweets sent by the influencers |
| 0.9978 | f₂₆ | Standard deviation of time (tᵢ₊₁ − tᵢ) |
| 0.9977 | f₃₂ | Highest % of co-located users |
| 0.9890 | f₃₃ | Second highest % of co-located users |
| 0.9832 | f₁₄ | If a journalist is in the group |
| 0.9645 | f₁₉ | Weight of web links |

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for identifying conversations in tweet streams, comprising:
grouping tweet messages in the tweet streams into tweet groups, responsive to hashtags therefor and time intervals in which the tweet message were sent;
splitting the tweet groups into subgroups responsive to secondary hashtags and a time separation between the tweets messages;
clustering any of the subgroups into a respective same conversation responsive to word occurrences, word frequencies, and account holders; and
merging any of the subgroups having different hashtags into the respective same conversation responsive to overlapping glossary and account lists,
wherein each of the tweet groups and each of the subgroups correspond to a respective different one of the conversations when unable to be split, clustered, or merged.

2. The method of claim 1, wherein the tweet groups are split into the subgroups, when the time separation between the tweets messages is greater than a predetermined amount of time.

3. The method of claim 2, wherein, irrespective of having a same hashtag, the tweets messages in the tweet groups split into the subgroups responsive to the time separation between the tweet messages being greater than the predetermined amount of time are considered to belong to different conversations.

4. A method for predicting the business impact of input tweet conversations, comprising:
creating training data that includes pre-selected tweet conversations, pre-selected hashtags from the pre-selected tweet conversations, and labels, each of the labels specifying a respective predicted business impact level for a respective one of the pre-selected tweet conversations and a respective one of the pre-selected hashtags included therein;
computing, by a processor, feature vectors for features extracted from the input tweet conversations; and
forming a prediction model, trained by the training data, for predicting a respective business impact level for each of the input tweet conversations, by mapping respective predicted business impact levels to one or more feature vectors of each of the input tweet conversations.

5. The method of claim 4, wherein said creating step is performed off-line.

6. The method of claim 4, wherein the corresponding business impacts included in the training data are expert-predicted business impacts.

7. The method of claim 4, further comprising initially grouping the input tweet conversations into groups of input tweet conversations, respective group memberships being based on having a respective same hashtag.

8. The method of claim 4, further comprising initially selecting the features for which the feature vectors are computed responsive to a measure of independence between observed feature values and expected frequencies of the observed feature value.

9. The method of claim 8, wherein the measure of independence is calculated under a null hypothesis that feature values are independent of an impact level.

10. The method of claim 9, wherein the measure of independence is calculated responsive to performing Pearson's chi-square test under the null hypothesis.

11. The method of claim 4, wherein the features comprise at least one of account features, keyword features, location features, language features, and time features.

12. The method of claim 4, wherein the feature weight vectors are calculated to minimize a prediction error of the business impact level responsive to the training data.

13. The method of claim 4, further comprising calculating feature weight vectors for the features, wherein an impact score used for predicting the business impact level for each of the input tweet conversations is determined responsive to the feature vectors and the feature weight vectors corresponding thereto.

14. The method of claim 13, wherein said calculating step comprises retrieving one or more feature weight values from a weight-to-hashtag data association construct that respectively associates different hashtags to respective feature weight values.

15. The method of claim 4, wherein the business impact level is predicted using a binary specifier, the binary specified being selected from a value of high and a value of low.

16. The method of claim 4, wherein the prediction model predicts the business impact level for each of the input tweet conversations using logistic regression.
